(19) United States
(12) Patent Application Publication
(10) Pub. No.: US 2020/0290011 A1
(43) Pub. Date: Sep. 17, 2020

(54) WIPER BAND ASSEMBLY FOR A PACKED DISTILLATION COLUMN

(71) Applicants: Paul William Belanger, Clarence Center, NY (US); Kirk F. Larson, Amherst, NY (US); Arya Ayaskanta, Tonawanda, NY (US); Mark A. Salay, Tonawanda, NY (US); John P. Ricotta, Kenmore, NY (US); Jeremy D. Faust, Amherst, NY (US); Richard D. Lenz, Tonawanda, NY (US)

(72) Inventors: Paul William Belanger, Clarence Center, NY (US); Kirk F. Larson, Amherst, NY (US); Arya Ayaskanta, Tonawanda, NY (US); Mark A. Salay, Tonawanda, NY (US); John P. Ricotta, Kenmore, NY (US); Jeremy D. Faust, Amherst, NY (US); Richard D. Lenz, Tonawanda, NY (US)

(21) Appl. No.: 16/352,905

(22) Filed: Mar. 14, 2019

(51) Int. Cl. B01J 19/32

(52) U.S. Cl. CPC B01J 19/325; B01J 2219/3221; B01J 2219/32227; B01J 2219/3222

(57) ABSTRACT

A wiper band assembly suitable for use in packed distillation columns used in an air separation unit is provided. The wiper band assembly includes specially designed metal or metal alloy wiper tabs that are longer and thinner than conventional wiper tabs. The longer and thinner wiper tabs preferably have a thickness between about 0.05 mm and 0.25 mm and a length greater than about 50.0 mm. The physical dimensions and characteristics of the wiper tabs are selected to avoid permanent deformation during the installation process and provides continuous engagement with the interior surface of the packed column wall when the wiper tabs are exposed to pressure differentials typically seen in such packed distillation columns.

### TECHNICAL FIELD

The present invention relates to a structured packing arrangement for packed columns, and more particularly to a wiper band assembly for reducing vapor bypass in the gaps between the structured packing and the packed distillation column wall using specially designed wiper tabs.

### BACKGROUND

Distillation columns with structured packing have been used in industrial distillation applications since the 1960's including, for example, distillation applications in chemistry, petroleum chemistry, refining, air separation, and absorption. The structured packing provides a large surface area for vapor-liquid contacting within the column which increases the overall effectiveness of the distillation column.

Structured packing is typically formed by vertical packing sheets of corrugated metal with the angle of the corrugations reversed in adjacent packing sheets to form a very open structure with inclined flow channels. To simplify installation, the structured packing is provided in pre-formed segments or bricks that are often sized to fit through the column access ports or manways. Structured packing is usually installed within the column in a plurality of layers of about 8 inches (˜204 mm) to about 12 inches (˜305 mm) high and with adjacent layers rotated 90 degrees. The vertical edge of each packing sheet is distinguished by the motion it imparts to liquid flowing on the respective edge. Some packing sheets are configured such that liquid flow at the vertical edge is directed inwards while neighboring packing sheets would have a vertical edge whose corrugations direct liquid flow in an outward direction towards the vertical wall surface.

Persons skilled in the art of distillation column design have long recognized the deleterious effect of excessive liquid flow along the column wall and there have been attempts to mitigate that effect, such as by the use of conventional wall wipers or wiper tabs. Such wall wipers or wiper tabs are located around the perimeter of each layer and provide a contact seal between the structured packing and the column wall and direct descending liquid from the column wall and back into the structured packing.

While such conventional wall wipers, wiper bands, and wiper tabs provide a generally effective solution to redirecting the descending liquid flow from the wall of the column back to the flow channels within the structured packing, there remains a problem with vapor bypass, particularly vapor bypass occurring around the perimeter of the packing (i.e. along the distillation column wall).

It has been observed for large packed distillation columns the packing often shifts during column handling and transport. This movement of the packing, due to small spaces between packing bricks, gaps around the column perimeter, and deformation of the packing itself opens up spaces around the perimeter of the packing through which the ascending vapor can bypass entire sections of packing. In addition, it has recently been observed that permanent deformation of conventional wiper band tabs during installation of the packing within the column and/or subsequent transport or shifting can result in unintended vapor bypass during column operation. Regardless of the source of vapor bypass, it is well known that any vapor bypass adversely impacts distillation column performance.

The deleterious effect of vapor bypass at the column wall has previously been addressed by the use of solid metal wall wipers or other restricting devices in the annular space near the column wall. One such example of using wiper tabs or wall wipers is briefly discussed in U.S. Pat. No. 5,700,403 where specially designed wall wipers are contemplated for use where such wall wipers encroach into voids or gaps of the structured packing sheets. Examples of other restricting devices such as solid wipers or gaskets disposed between the structured packing and the column wall are disclosed in the European Patent Application No. 0997189 A1 entitled “Devices to Minimize Vapor Bypass in Packed Column and Method of Assembly”.

U.S. Pat. No. 5,456,865 presents a vapor bypass solution whereby a crown element is installed around the perimeter of the packing. It is not physically attached to the packing but rather is held in place via spring force and frictional force. Similarly, U.S. Pat. No. 8,807,541 discloses a similar arrangement that includes a ‘roof element’, a bottom element with ‘V’ shaped grooves which are bent in the opposite direction of the ‘roof element’, and two wall surfaces. The ‘roof element’ is specified to be of a thickness in the range from 0.05 mm to less than 2 mm, and preferably 1.5 mm. The teaching in U.S. Pat. No. 8,807,541 states that the rationale behind the design is to facilitate bending of the roof element from a cylindrical shape into a conical shape, and not the avoidance of permanent deformation. The teaching in U.S. Pat. No. 8,807,541 also states that the ‘roof element’ is subjected to a bending moment which helps to retain the crown in place, as opposed to allowing them to spring back into shape as the packing moves away from the wall.

European Patent No. 0913192 is yet another improvement upon the vapor bypass arrangements and devices shown in U.S. Pat. Nos. 5,456,865 and 8,807,541. In European Patent No. 0913192, the concern is the prevention of crushing of the collars under the weight of the packing during horizontal installation or transportation. To address this problem. rigid elements are installed to prevent deformation of the collar under the weight of the packing.

Another relevant prior art solution to the problem of vapor bypass is disclosed in European Patent No. 0867220 where the disclosure includes a means of preventing vapor bypass by including a ‘barrier film’ around the perimeter of the structured packing which can consist of metal, plastic, rubber, or foam. Any material that is flexible and can conform to the column shell is deemed permissible. The means of maintaining contact between the film and the column shell in European Patent No. 0867220 was indicated to be not critical.

What is needed, therefore, is an improved wiper band assembly with wiper tabs that minimize vapor bypass along the column wall in a packed distillation column without adversely impacting distillation column performance.

### SUMMARY OF THE INVENTION

The present wiper band and structured packing assembly may be broadly characterized as a system and method for minimizing vapor bypass in a packed distillation column by employing improved wiper bands having wiper tabs that are longer and thinner compared to conventional wiper tabs. The longer and thinner wiper tabs are also sufficiently rigid so as to provide continuous engagement between the with the interior surface of the packed column wall when the wiper tabs are exposed to pressure differentials typically seen in such packed distillation columns.

More specifically, the present wiper band and structured packing assembly comprises: (i) a structured packing element having a vertical height of not less than 125.0 mm and a defined perimeter configured to be juxtaposed to an interior surface of a packed column; (ii) one or more wiper bands attached to the defined perimeter of the structured packing element; and (iii) a plurality of flexible wiper tabs extending from the wiper bands and bent away from the defined perimeter of the structured packing element at an initial bend angle between about 20 degrees and about 45 degrees. The plurality of flexible wiper tabs each have a thickness between about 0.05 mm and about 0.25 mm and a length greater than about 50.0 mm but less than about 40% of the vertical height of the structured packing element installed in the packed column. In some embodiments, the plurality of flexible wiper tabs each have a tab length to tab width ratio of greater than about 1.0. The wiper tabs are also sufficiently rigid to remain engaged with the interior surface of the packed column wall when exposed to a typical pressure differential of about 0.0015 bar within the distillation column.

Preferably, the wiper band and structured packing assembly is configured for use in packed distillation column in an air separation unit where the structured packing comprises structured packing elements or bricks arranged within the column so as to define a gap of at least 2.0 mm between the defined perimeter of the structured packing and the interior surface of the column wall. To ensure presence of the gap, the present wiper band and structured packing assembly includes one or more spacer tabs each having a width between about 2.0 mm and 12.0 mm and that are attached to the one or more wiper bands.

The wiper bands and the plurality of flexible wiper tabs are constructed of a metal or metal alloy selected from the group consisting of stainless steel, aluminum, aluminum alloys, copper or copper alloys and avoid permanent deformation at a bending stress of less than the reported yield stress of the metal or metal alloy. To increase the net effective length of the wiper tab, the wiper tab may be formed from a corrugated metal sheet. To facilitate attachment of the wiper band assembly to the structured packing elements or bricks, the wiper band includes a plurality of holes through which attachment screws are used to attach the wiper bands to the structured packing element.

### BRIEF DESCRIPTION OF THE DRAWINGS

While the specification concludes with one or more claims specifically pointing out the subject matter that Applicants regard as the invention, it is believed that the invention will be better understood when taken in connection with the accompanying drawings in which:

FIG. 1 depicts a perspective view of a partial section of a structured packing with wiper band assembly;

FIG. 2 depicts a partial view of an unattached wiper band with wiper tabs in accordance with one embodiment of the invention;

FIG. 3 depicts a partial view of the wiper bands with a first set and a second set of wiper tabs in accordance with an alternate embodiment of the invention;

FIG. 4 is an illustration or representation of a section of a distillation column with the structured packing assembly disposed therein;

FIG. 5 is an illustration or representation of a section of a distillation column with structured packing assembly of FIG. 1 with the structured packing assembly pushed against the column wall as may occur during installation or transport of the column;

FIG. 6 is an illustration or representation of a section of a distillation column with structured packing assembly of FIG. 1 with the structured packing assembly shifting away from the column wall as may occur during installation or transport of the column;

FIG. 7 depicts the geometrical relationships used in the derivation of key formulas related to stress and strain;

FIG. 8 illustrates for stainless steel wiper tabs of varying thickness and initial bend angles the minimum tab length required to avoid permanent deformation as the packing is pushed against the column wall as is illustrated in FIG. 5;

FIG. 9 illustrates for wiper tabs of varying thickness and initial bend angles the amount of overlap (i.e. the amount of gap between outer perimeter of packing and the column shell that will be occupied by the tabs) the wiper tabs will provide; and

FIG. 10 illustrates experimental results showing the percent deformation of the wiper tab vs. calculated stress for stainless steel wiper tabs of varying thickness and having a length greater than or equal to 2 inches.

### DETAILED DESCRIPTION

### Structured Packing Element With a Wiper Band Assembly

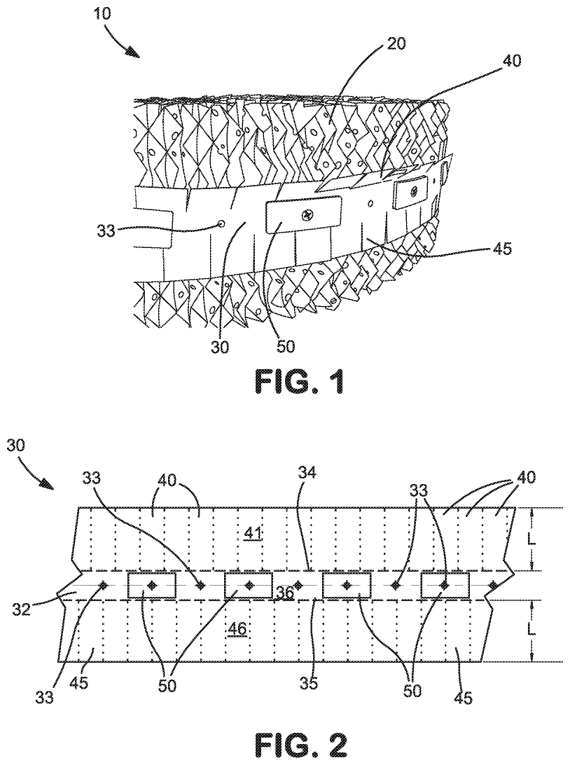

With reference to the FIG. 1, there is shown a perspective view of a section of a structured packing element 20 with a wiper band assembly 10 attached thereto. Although not shown in the figure, the distillation column arrangement into which the illustrated assembly is installed preferably includes one or more beds of structured packing all disposed within an interior region of the distillation column. The illustrated structured packing assembly 10 includes a structured packing element 20, a metal wiper band 30 with wiper tabs 40,45, and spacer tabs 50. The structured packing assembly 10 is typically installed within the distillation column as close as possible to the interior surface of the column wall in an effort to minimize liquid wall flow and vapor bypass along the packed column wall.

The preferred embodiments of the structured packing element suitable for use with the improved wiper band assembly is the traditional structured packing generally formed from corrugated sheets of perforated metal or plastic. The resulting structure is a very open honeycomb-like structure with inclined flow channels of the corrugations giving a relatively high surface area but with very low resistance to gas flow. In distillation column applications using structured packing, the structured packing is preferably constructed of materials selected from the group consisting of: aluminum sheet metal, stainless steel sheet metal, stainless steel gauze, and plastic. The surfaces of the structured packing may be smooth or may include surface texturing such as grooving, fluting, or patterned impressions on the surfaces of the structured packing sheets. Examples of the preferred types of structured packing are shown and described in U.S. Pat. Nos. 5,632,934 and 9,295,925.

The size or configuration of structured packing is broadly defined by the surface area density of the packing and the inclination angle of the corrugated flow channels in the main mass transfer section of the structured packing. The preferred density of the structured packing is between about 100 m²/m³ to 1200 m²/m³ and more preferably are selected from the group of commercially available structured packing having surface area densities of 110 m²/m³; 220 m²/m³; 250 m²/m³; 350 m²/m³; 430 m²/m³; 500 m²/m³; 730 m²/m³; 950 m²/m³; and 1200 m²/m³. The geometry of the structured packing, as characterized by the inclination angle of the corrugated flow channels in the main mass transfer section of the structured packing, preferably includes a nominal inclination angle to the horizontal axis of between about 35° to 70°.

The preferred structured packing configuration includes a plurality of conventional rectangular bricks. The preferred height of the bricks is between about 8 inches (˜204 mm) and 12 inches (˜305 mm), although half-height bricks of about 4 inches (˜102 mm) to about 6 inches (152 mm) may also be used.

The structured packing arrangement within a distillation column preferably comprises two or more beds of structured packing elements. Where multiple beds of structured packing elements are employed, the adjacent beds may have the same or different surface area densities and/or different geometries. For example, a first bed of structured packing elements having a first surface area density while a second bed structured packing elements having a second surface area density may be disposed above or below the first bed of structured packing elements. Similarly, the first bed of structured packing elements may have a first nominal inclination angle to the horizontal axis whereas the second bed of structured packing elements may have a different nominal inclination angle to the horizontal axis.

### Movement of the Structured Packing and Wiper Tabs Within the Distillation Column

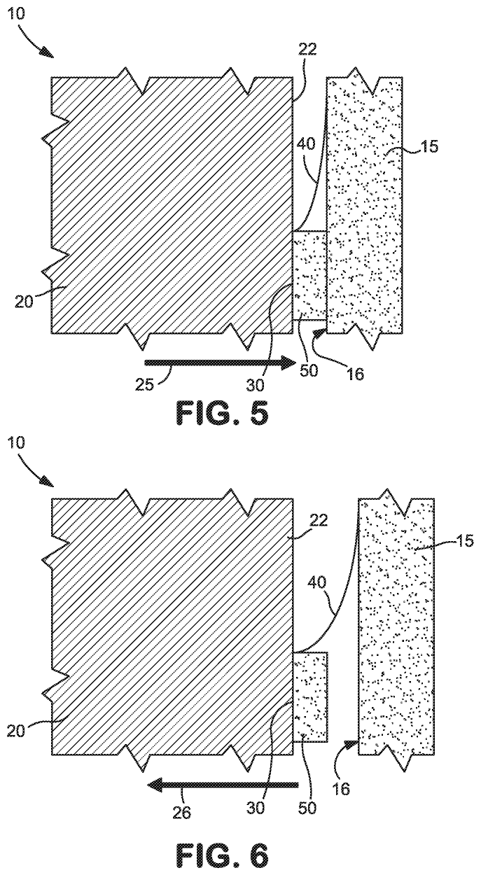

Illustrations showing conventional wiper band assemblies and wiper tabs installed in a packed distillation column are shown in FIGS. 4-6. FIG. 4 depicts the wiper band assembly 10 and wiper tabs 40 prior to installation within a distillation column. The plurality of wiper tabs 40 are only attached to the structured packing elements 20 or bricks on the perimeter and in close proximity to the distillation column wall 15. The interior structured packing elements or bricks not in contact or not in close proximity to the distillation column wall 15 do not need wiper band assemblies 10. The spacer tabs 50 or plates are disposed between the wiper band and the interior surface 16 of the distillation column wall to prevent the exterior surface 22 of the structured packing elements 20 or bricks from sinking into the column wall 15 during installation and transport and generally keep the structured packing elements 20 or bricks from deforming. During structured packing installation, the perimeter structured packing elements 20 or bricks are pushed in the direction of arrow 25 towards the interior surface 16 of the distillation column wall 15 and the wiper tab 40 generally takes the shape as shown in FIG. 5.

Conventional wiper tabs often permanently deform when pushed against the interior surface 16 of the distillation column wall 15 during installation of the structured packing. As a result, if the structured packing elements 20 or bricks later shift in the direction of arrow 26 of FIG. 6 during transport, column assembly or other event after installation, the wiper tabs 40 may change shape and may not spring back to cover the gap between the packed section and the column wall. Such a gap represents an opportunity for vapor bypass which in turn adversely impacts distillation column performance. To prevent any such gap from forming and avoid permanent deformation of the wiper tab 40 during installation, one must design wiper band assemblies that employ wiper tabs that are thinner and longer than conventional wiper tabs.

### Wiper Band Assembly

Turning now to FIG. 2, there is shown a preferred embodiment of the present wiper band assembly 30. In its most basic form, the wiper band assembly 30 includes a wiper band 32 with a plurality of wiper tabs 40, 45 extending therefrom. The wiper band 32 preferably includes a top edge portion 34, a bottom edge portion 35, an exterior surface 36, and an interior surface (not shown). The wiper band 32 is sized to run along a defined perimeter of a structured packing element 20 (e.g. structured packing brick) such that the interior surface of the wiper band contacts the outwardly facing edge 22 of the structured packing element 20. The exterior surface 36 of the wiper band 32 would be facing the distillation column wall 16. The wiper band 32 also includes a plurality of attachment holes 33 in which attachment screws are inserted to securely attach the wiper band 32 to the structured packing element 20.

Extending from the top edge portion 34 is a first set of wiper tabs 40. Likewise, a second set of wiper tabs 45 also extend from the bottom edge portion 35 of the wiper band 32. The plurality of wiper tabs 40, 45 are configured to be bent outwardly at a prescribed angle Θ relative to the exterior surface 36 of the wiper band 32. The initial bend angle of the flexible wiper tabs is preferably between about 20 degrees and 45 degrees as measured from the vertical plane of the wiper band.

The plurality of flexible wiper tabs 40,45 each have an upper surface 41,46 and a lower surface (not shown), a length (L) preferably greater than about 50 mm and a thickness (t) of between about 0.05 mm and about 0.25 mm. From a practical standpoint, the length (L) of the wiper tab 40,45 is limited, preferably to about 40% of the vertical height of the structured packing element or structured packing brick. In other words, the combined height of the wiper tabs (upwardly extending and downwardly extending) plus the height of the wiper band is preferably less than the height of the structured packing brick. Such wiper tab height limitation facilitates ease of installation of the structured packing elements or structured packing bricks in the packed distillation column.

The wiper band 32 and the wiper tabs 40,45 are preferably constructed of a metal or metal alloy selected from the group consisting of stainless steel, aluminum, aluminum alloys, copper or copper alloys and avoid permanent deformation at stresses typically encountered when used in packed distillation columns. Preferably, the wiper band 32 and wiper tabs 40,45 are formed from a continuous metal sheet cut in a way to delineate the wiper band from the wiper tabs. In some embodiments, wiper tab may be formed from a corrugated metal sheet to increase the net effective length of the wiper tab.

The illustrated wiper band assembly 30 further includes one or more spacer tabs 50 attached to the wiper band 32. The spacer tabs 50 preferably have a width of between about 2.0 mm and about 12.0 mm. As discussed in more detail below the width of the spacer tabs is a critical parameter to consider when designing the wiper band assembly, and more particularly the length (L) and thickness (t) of the wiper tabs 40,45.

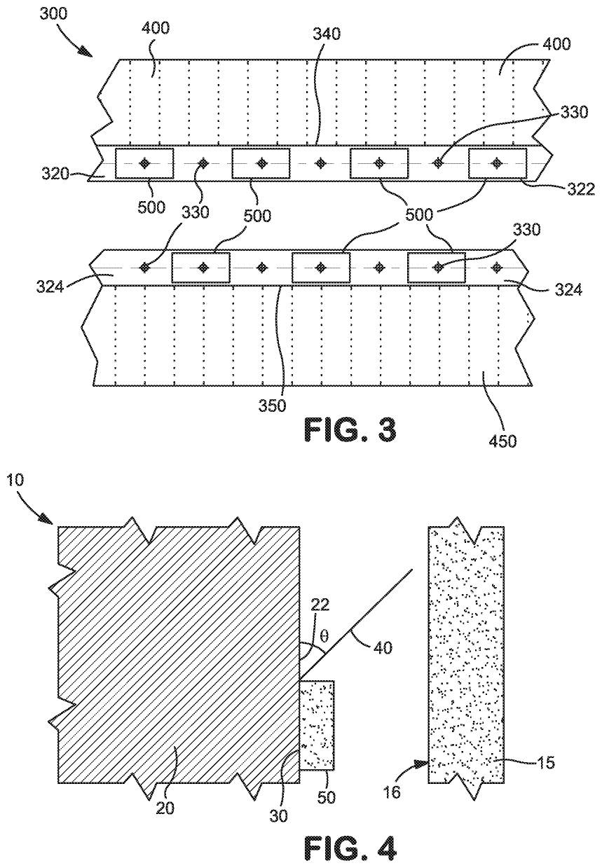

FIG. 3 depicts an alternate embodiment of the wiper band assembly 300. As seen therein, this embodiment utilizes multiple wiper bands, namely a first wiper band 322 and a second wiper band 324. The plurality of wiper tabs include a first set of wiper tabs 400 connected to a top edge 340 of the first wiper band 322 and a second set of wiper tabs 450 connected to a bottom edge 350 of the second wiper band 324. This contemplated embodiment also includes attachment holes 330 and spacer tabs 350. The dimensions and construction of the multiple wiper bands 332, 334, plurality of wiper tabs 400,450 and spacer tabs 350 are similar to that described above with reference to FIG. 2.

### Avoiding Permanent Deformation of the Wiper Tabs

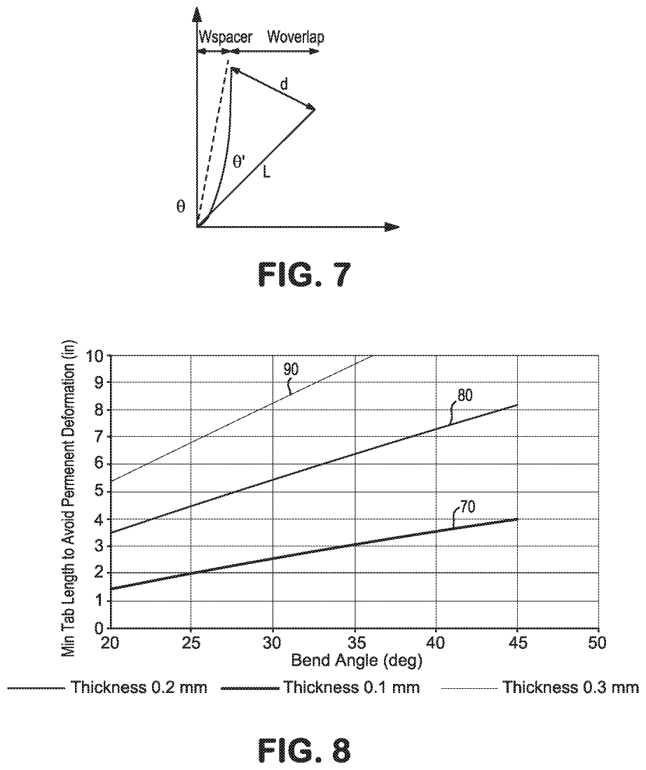

FIG. 7 shows the geometry used in developed simulation models to represent a wiper tab as a cantilever member displaced on one end. Using the simulated geometry of FIG. 7 and Equation 1 below, one can design a wiper band assembly with wiper tabs that act or function more like a spring and thereby avoiding permanent deformation during the installation process. Simulating the wiper tab as a cantilevered member with a load applied to the distal end, Equation 1 expresses the maximum stress in the wiper tab (σₘₐₓ) as a function of various parameters including wiper tab length (L), wiper tab thickness (t), width of the spacer tab (W_{spacer}), bend angle of the wiper tab (Θ), and the modulus of elasticity of the chosen material of construction (E) of the wiper tab.

Equation 1 is used to assist in the design the wiper tab and wiper band assembly. By selecting and/or optimizing selected parameters, including wiper tab length, thickness, bend angle, and material of construction, one can design an improved wiper tab such that the maximum stress (σₘₐₓ) does not exceed the yield stress of the chosen material of construction. Using these wiper tab design parameters, the wiper tabs will bow upon packing installation rather than permanently deform. For stainless steel, a common material of construction for wiper tabs, the modulus of elasticity is 29000 ksi and the yield stress is approximately 31200 psi.

$${σ}_{max} = \frac{3 \cdot E \cdot t}{L} \cdot sin ( \frac{θ - \frac{π}{2} + a cos ( \frac{{W}_{spacer}}{L} )}{2} ) \qquad Equation 1$$

where:

E is the Modulus of Elasticty of the Wiper Tab material;

t is the Thickness of the Wiper Tab

L is the Length of the Wiper Tab

Θ is the Bend Angle of the Wiper Tab

σₘₐₓ is the maximum stress in the Wiper Tab; and

W_{spacer} is the Width of the Spacer

Error! Reference source not found. shows the wiper tab length needed to avoid permanent deformation as a function of wiper tab thickness and bend angle for stainless steel wiper tab with a 0.125 inch thick spacer tab. As can be seen in FIG. 8, a 0.2 mm thick wiper tab (represented by line 80) bent at a bend angle of about 45 degrees requires a wiper tab length greater than 8 inches to avoid permanent deformation, which is not practical given the height of most conventional structured packing elements is between 4.0 inches and 12.0 inches. As the bend angle is decreased, the wiper tab length can be made smaller but even with a very small initial bend angle a wiper tab length of nearly 3.5 inches would be required for a 0.2 mm thick wiper tab to avoid permanent deformation. On the other hand, selecting a 0.1 mm thick stainless steel wiper tab design (represented by line 70) allows for the selection of a wiper tab length of only about 2 inches for a bend angle up to 25 degrees while still avoiding permanent deformation. Such a wiper tab design will enable the wiper tab to spring back to its original shape if and when the structured packing element moves away from the column wall. Use of even thicker wiper tabs, such as a 0.3 mm thick wiper tab (represented by line 90) requires wiper tab lengths of over 5 inches, which simply may not be practical.

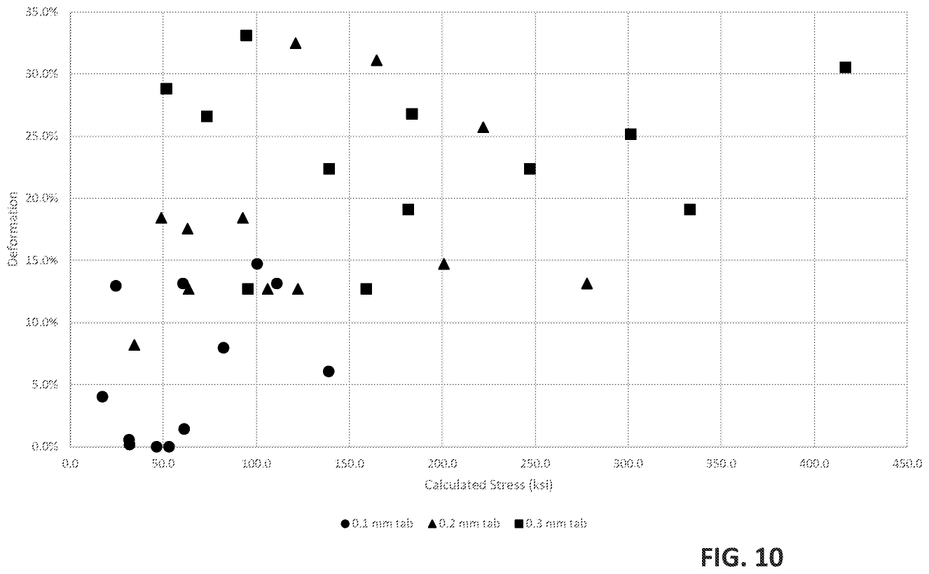

According to Equation 1, it is not surprising that thicker wiper tabs generally exhibit a greater amount of permanent deformation than thinner wiper tabs. What is surprising is that thin wiper tabs exhibited little to no permanent deformation in experimental studies, even when the bend angle was as much as 45 degrees, as shown in FIG. 10 which depicts the percent deformation versus calculated stress for stainless steel wiper tabs of various thickness having a length greater than or equal to 2 inches. Also, it has been found that the combined effect of longer and thinner wiper tabs significantly reduces vapor bypass compared to the shorter and thicker wiper tab designs conventionally used in many distillation columns.

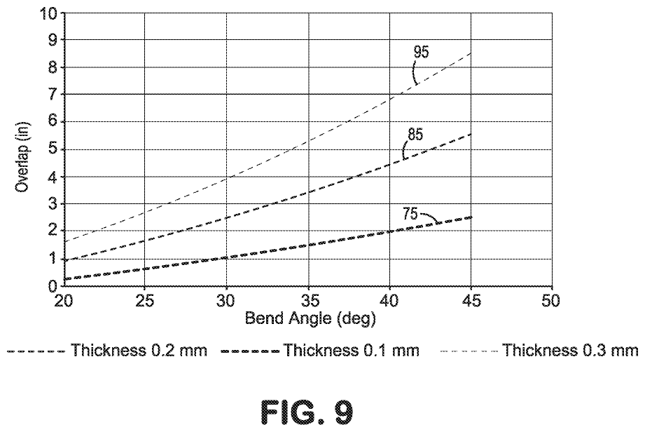

FIG. 9 shows for various wiper tab designs how far a stainless steel wiper band tab can be expected to extend past the spacer tab, provided the wiper tab is designed to have a length to avoid permanent deformation (i.e. sized according to Error! Reference source not found. and Equation 1). Line 75 represents wiper tabs having a thickness of 0.1 mm whereas line 85 represents wiper tabs having a thickness of 0.2 mm and line 95 represents wiper tabs having a thickness of 0.3 mm. The overlap (expressed in inches) is a direct indication of how far the structured packing element can move away from the interior surface of the column wall before the wiper tabs become disengaged from the distillation column wall. For wiper tabs whose length is selected according to Equation 1 and Error! Reference source not found., one can see the amount of coverage provided as a function of bend angle and wiper tab width. For example, a 0.1mm thick wiper band (represented by line 85) with a 25 degree bend angle (a 2″ tab length according to Error! Reference source not found.), the tab can be expected to spring back to extend about 0.75 inches beyond the edge of the spacer tab. Thus, this wiper tab design can accommodate significant shifting of the packing before a channel will open to allow vapor bypass. The more coverage that can be provided the better; however, there are practical limits on how long a wiper tab can be. For example, while ≥4 inches long stainless steel wiper tabs would satisfy the minimum coverage requirements for all thicknesses and initial bend angles of wiper tabs, a length of ≥4 inches is simply not practical due to the standard packing brick heights used in industry.

Moreover, given the amount of overlap together with the physical dimensions and characteristics of the wiper band assembly, the wiper tabs will remain engaged or in contact with the interior surface of the packed column wall when exposed to ascending flows within the distillation column at typical pressure differentials of about 0.0015 bar within the distillation column.

In order to meet the minimum coverage criteria while also avoiding permanent deformation using a stainless steel material of construction, a wiper tab design greater than about 50 mm (˜2.0 inches) in length with a wiper tab thickness of 0.25 mm or less is preferred. The initial bend angle of this preferred stainless steel wiper tab is between about 20 degrees and about 45 degrees. More preferably, the wiper tab thickness should be between about 0.05 mm and about 0.25 mm while the wiper tab length should preferably be greater than about 50.0 mm, but from a practical standpoint, the wiper tab length should also be less than about 40% of the vertical height of the structured packing element installed in the packed column.

While the present invention has been described with reference to a preferred embodiment or embodiments, it is understood that numerous additions, changes and omissions can be made without departing from the spirit and scope of the present invention as set forth in the appended claims.

What is claimed is:

1. A wiper band and structured packing assembly comprising:
a structured packing element having a vertical height of not less than 125.0 mm and a defined perimeter configured to be juxtaposed to an interior surface of a packed column;
one or more metal wiper bands attached to the defined perimeter of the structured packing element, the one or more metal wiper bands each having at least one edge portion,
a plurality of flexible wiper tabs connected to the at least one edge portion of the one or more metal wiper bands, the plurality of flexible wiper tabs each having an upper surface and a lower surface and each flexible wiper tab extending away from the defined perimeter of the structured packing element at an initial bend angle between about 20 degrees and about 45 degrees;
wherein the plurality of flexible wiper tabs each have a thickness between about 0.05 mm and about 0.25 and
wherein the plurality of flexible wiper tabs each have a tab length greater than about 50.0 mm but less than about 40% of the vertical height of the structured packing element installed in the packed column.

2. The wiper band and structured packing assembly of claim 1 wherein the packed column is a distillation column in an air separation unit and the structured packing element is further configured to be juxtaposed against to an interior surface of the packed column to define a gap of at least 2.0 mm between the defined perimeter and the interior surface of the packed column.

3. The wiper band and structured packing assembly of claim 1 further comprising one or more spacer tabs attached to the one or more metal wiper bands, the one or more spacer tabs each having a width between about 2.0 mm and about 12.0 mm.

4. The wiper band and structured packing assembly of claim 1, wherein the plurality of flexible wiper tabs are constructed of a metal or metal alloy selected from the group consisting of stainless steel, aluminum, aluminum alloys, copper or copper alloys and avoid permanent deformation and at a bending stress of less than the reported yield stress of the metal or metal alloy.

5. The wiper band and structured packing assembly of claim 2 wherein the plurality of flexible wiper tabs are configured to provide continuous engagement between the structured packing element and the interior surface of the packed column and remain engaged with the interior surface of the packed column when exposed to a pressure differential of 0.0015 bar between the column pressure at the lower surfaces of the plurality of wiper tabs and the column pressure as measured at the upper surfaces of the plurality of wiper tabs.

6. The wiper band and structured packing assembly of claim 1 wherein the one or more metal bands include a plurality of holes and the wiper band and structured packing assembly further comprises a plurality of attachment screws configured to attach the one or more metal bands to the structured packing element via the holes.

7. The wiper band and structured packing assembly of claim 1 wherein the plurality of wiper tabs further comprise a first set of wiper tabs connected to a top edge of the one or more metal wiper bands and a second set of wiper tabs connected to a bottom edge of the one or more metal wiper bands.

8. The wiper band and structured packing assembly of claim 1 wherein there one or more metal wiper bands comprise a first metal wiper band and a second metal wiper band and the plurality of wiper tabs further comprise a first set of wiper tabs connected to a top edge of the first metal wiper band and a second set of wiper tabs connected to a bottom edge of the second metal wiper band.

9. The wiper band and structured packing assembly of claim 1 wherein the flexible wiper tabs are formed from the same material as the one or more metal tabs and the wiper tabs and metal wiper bands are a continuous metal structure.

10. The wiper band and structured packing assembly of claim 1 wherein surfaces of the plurality of flexible wiper tabs are corrugated metal.

11. A wiper band and structured packing assembly comprising:
a structured packing element having a defined perimeter configured to be juxtaposed to an interior surface of a packed column and defining a gap between the defined perimeter and the interior surface of a packed column;
one or more metal bands attached to the defined perimeter of the structured packing element, the one or more metal bands each having at least one edge portion,
a plurality of flexible wiper tabs connected to the at least one edge portion of the one or more metal bands, the plurality of flexible wiper tabs each having an upper surface and a lower surface and each flexible wiper tab extending away from the defined perimeter of the structured packing element at an initial bend angle between about 20 degrees and about 45 degrees;
wherein the plurality of flexible wiper tabs each have a thickness between about 0.05 mm and about 0.25 mm; and
wherein the plurality of flexible wiper tabs each have a tab length to tab width ratio of greater than about 1.0.

12. The wiper band and structured packing assembly of claim 11 wherein the structured packing element has a vertical height of not less than 125.0 mm.

13. The wiper band and structured packing assembly of claim 11 wherein the plurality of flexible wiper tabs each have a tab length of not less than about 50.0 mm.

14. The wiper band and structured packing assembly of claim 11 wherein the plurality of flexible wiper tabs each have a tab width of at least about 20.0 mm.

15. The wiper band and structured packing assembly of claim 11 wherein the plurality of flexible wiper tabs each have a tab length of not greater than about 40% of the vertical height of the structured packing element.

16. The wiper band and structured packing assembly of claim 11 wherein the packed column is a distillation column in an air separation unit and the structured packing element is further configured to be juxtaposed against to an interior surface of the packed column to define a gap of at least 2.0 mm between the defined perimeter and the interior surface of the packed column.

17. The wiper band and structured packing assembly of claim 16 wherein the plurality of flexible wiper tabs are configured to provide continuous engagement between the structured packing element and the interior surface of the packed column and remain engaged with the interior surface of the packed column when exposed to a pressure differential of 0.0015 bar between the column pressure at the lower surfaces of the plurality of wiper tabs and the column pressure as measured at the upper surfaces of the plurality of wiper tabs.

18. The wiper band and structured packing assembly of claim 11 further comprising one or more spacer tabs attached to the one or more metal bands, the one or more spacer tabs each having a width between about 2.0 mm and about 12.0 mm.

19. The wiper band and structured packing assembly of claim 11, wherein the plurality of flexible wiper tabs are constructed of a metal or metal alloy selected from the group consisting of stainless steel, aluminum, aluminum alloys, copper or copper alloys and avoid permanent deformation and at a bending stress of less than the reported yield. stress of the metal or metal alloy. 20, The wiper band and structured packing assembly of claim 11 wherein the one or more metal bands include a plurality of holes and the wiper band and structured packing assembly further comprises a plurality of attachment screws configured to attach the one or more metal bands to the structured packing element via the holes.

21. The wiper band and structured packing assembly of claim 11 wherein the plurality of wiper tabs further comprise a first set of wiper tabs connected to a top edge of the one or more metal bands and a second set of wiper tabs connected to a bottom edge of the one or more metal bands.

22. The wiper band and structured packing assembly of claim 11 wherein there one or more metal bands comprise a first metal band and a second metal band and the plurality of wiper tabs further comprise a first set of wiper tabs connected to a top edge of the first metal band and a second set of wiper tabs connected to a bottom edge of the second metal band.

23. The wiper band and structured packing assembly of claim 11 wherein the flexible wiper tabs are formed from the same material as the one or more metal tabs and the wiper tabs and metal bands are a continuous metal structure.

24. The wiper band and structured packing assembly of claim 11 wherein surfaces of the plurality of flexible wiper tabs are corrugated metal.
